(19) United States
(12) Patent Application Publication
(10) Pub. No.: US 2026/0048688 A1
(43) Pub. Date: Feb. 19, 2026

(54) CHILD SAFETY SEAT

(71) Applicant: WONDERLAND SWITZERLAND AG, Steinhausen (CH)

(72) Inventor: Daliang ZHANG, Dongguan, Guangdong (CN)

(73) Assignee: WONDERLAND SWITZERLAND AG, Steinhausen (CH)

(21) Appl. No.: 19/103,146

(22) PCT Filed: Aug. 9, 2023
(86) PCT No.: PCT/EP2023/072095

§ 371 Date: Feb. 11, 2025

(30) Foreign Application Priority Data
Aug. 11, 2022 (CN) 202210962411.3

(51) Int. Cl. B60N 2/28

(52) U.S. Cl. CPC B60N 2/2869; B60N 2/2821

(57) ABSTRACT

A child safety seat includes a base; a turntable located above the base and may rotate between a forward position and a rearward position; a seat located above the turntable; and an anti-misuse mechanism arranged between the base, the turntable and the seat, and including an operating member, wherein the operating member is installed on the child safety seat and may move between a first position and a second position with respect to the seat, so that the anti-misuse mechanism can prevent or allow the relative rotation between the turntable and the base; wherein, when the operating member approaches the first position across an intermediate position between the first position and the second position, the operating member automatically moves to the first position; and when the operating member approaches the second position across the intermediate position, the operating member automatically moves to the second position.

### TECHNICAL FIELD

The present disclosure relates to a child safety seat including an anti-misuse mechanism.

### BACKGROUND

Child safety seats are secured to a vehicle such as an automobile, so as to provide a safe riding environment for children.

In some cases, the child safety seat is provided to be rotatable about a vertical axis by 360 degrees, that is, the seat may rotate between a forward position (a traveling direction in which the seat faces towards the vehicle) and a rearward position (a traveling direction in which the seat faces away from the vehicle). In order to ensure safety, children under 15 months should generally use the child safety seat in the rearward position. In order to prevent users from mistakenly placing the children under 15 months in the child safety seat being in the forward position, some child safety seats are provided with an anti-misuse mechanism in a rotating direction.

In the child safety seat provided with the anti-misuse mechanism, through an operating member of the anti-misuse mechanism, the user can switch the child safety seat to an unlocking mode in which the child safety seat is switchable to the forward position or a locking mode in which the child safety seat is not switchable to the forward position. However, there is no automatic pushing and positioning mechanism for the operating member of the existing anti-misuse mechanism, and the operator may not operate the operating member in place, so that modes of the seat are not actually switched, which finally leads to the misuse of the seat direction, and possibly negatively affecting the traveling safety of children.

Generally, a turntable is provided between the seat and the base to allow the seat to rotate between the forward position and the rearward position. In some cases, it is desirable that the seat may be separated from the turntable so as to change the seat or move the seat to other use environments.

Therefore, it is necessary to provide an anti-misuse mechanism for a child safety seat, in which the operating member may be automatically pushed and positioned, and the seat is allowed to be separated from the turntable.

### SUMMARY

A child safety seat according to the present disclosure includes a base; a turntable located above the base and rotatable between a forward position and a rearward position with respect to the base about a substantially vertical axis; a seat located above the turntable and rotatable together with the turntable, wherein the forward position is a position where the turntable enables the seat to face forward, and the rearward position is a position where the turntable enables the seat to face rearward; and an anti-misuse mechanism arranged between the base, the turntable and the seat, and including an operating member, wherein the operating member is mounted on the child safety seat and is movable between a first position and a second position with respect to the seat, so that the anti-misuse mechanism prevents or allows a relative rotation between the turntable and the base; wherein, when the operating member passes over an intermediate between the first position and the second position and approaches the first position, the operating member automatically moves to the first position; and when the operating member passes over an intermediate and approaches the second position, the operating member automatically moves to the second position.

In one embodiment, the anti-misuse mechanism further includes a positioning member disposed on the child safety seat and abuts against the operating member for automatically moving the operating member to the first position or the second position when the operating member approaches the first position or the second position.

In one embodiment, the operating member includes a ridge, and the ridge protrudes towards the positioning member and abuts against the positioning member, so that the operating member automatically moves to the first position or the second position.

In one embodiment, the operating member includes a sliding part slidable with respect to the child safety seat; and two positioning recesses disposed on the sliding part. The positioning member includes a protrusion. When the operating member is positioned near to the intermediate position, the protrusion abuts against the ridge, so that the operating member automatically moves to the first position or the second position; and after the operating member passes over the intermediate position and approached the first position or the second position, the protrusion abuts against a corresponding positioning recess and pushes the operating member to the first position or the second position.

In one embodiment, the operating member further includes a toggling part connected to the sliding part and configured to drive the sliding part to slide with respect to the child safety seat.

In one embodiment, each of the positioning recesses extends with respect to the sliding part in a cambered shape, and the protrusion has an arc profile adapted to the positioning recess.

In one embodiment, the protrusion is movable with respect to the positioning member body.

In one embodiment, the ridge is formed between the two positioning recesses, and the ridge is cambered at a position facing towards the protrusion.

In one embodiment, the anti-misuse mechanism further includes a linkage swinging about a transverse axis, and the operating member abuts against one end of the linkage, and a transverse movement of the operating member drives the linkage to swing.

In one embodiment, the operating member comprises an inclined surface part, and an upper surface of the inclined surface part extends obliquely in a manner that one end thereof is higher than the other end in a lateral direction. The linkage includes a handle kept against the upper surface of the inclined surface part; and a pivot spaces apart from the handle, the linkage is configured to swing about the pivot. When the operating member moves from the first position to the second position or from the second position to the first position, the handle abuts against and slides on the upper surface of the inclined surface and moves in a vertical direction to drive the linkage to swing.

In one embodiment, the pivot is engaged under a crossbar installed on the seat, so that the linkage may swing about the crossbar.

In one embodiment, the anti-misuse mechanism further includes a pushing member arranged in the seat and restricted to move vertically. The other end of the linkage with respect to the handle is coupled to an upper end of the pushing member, and the linkage is swung to drive the pushing member to move vertically.

In one embodiment, the linkage further includes a fork located at the other end of the linkage with respect to the handle, and having two arms arranged on both sides in the lateral direction with respect to a longitudinal center of the pushing member, and the pushing member is pivotally connected between the two arms through a pushing member pin.

In one embodiment, the anti-misuse mechanism further includes a driving part arranged in the turntable, vertically below the pushing part, and restricted to be movable vertically. A lower end of the pushing member abuts against the upper end of the driving member, and a vertical movement of the pushing member enables the driving member to move vertically.

In one embodiment, the anti-misuse mechanism further includes a driven member arranged in the turntable and restricted to move in a longitudinal direction. The driven member is coupled with the driving part, so that a vertical movement of the driving part drives the driven member to move longitudinally.

In one embodiment, the driven member is provided with two side walls extending longitudinally and an opened top part, and each of the side walls is symmetrically provided with a sliding groove with an inclined edge with respect to the longitudinal direction. A driving member pin extending transversely outward from each of opposite sides of the driving member is provided on the driving member, and the driving member pin is inserted into the corresponding sliding groove and kept against the corresponding inclined edge.

In one embodiment, the child safety seat further includes a projection at least partially arranged in the turntable and being movable between a locking position where the projection extends from the turntable and an unlocking position where the projection is retracted into the turntable. The projection is arranged a position where the driven member is near an outer side of the turntable, and a longitudinal movement of the driven member drives the projection to move between the locking position and the unlocking position.

In one embodiment, the anti-misuse mechanism further includes a positioning member spring arranged between the positioning member and the seat, and biasing the positioning member upwards; a pushing member spring arranged between the pushing member and the seat, and biasing the pushing member upwards; and a driving member spring arranged between the driving member and the turntable, and biasing the driving member upwards.

In one embodiment, the sliding groove is a groove having a shape of an approximately right triangle, and a hypotenuse of the right triangle is located at a side of the sliding groove in the longitudinal direction and acts as the inclined edge. The anti-misuse mechanism further comprises a driven member spring, the driven member spring is arranged between the driven member and the turntable, and biases the driven member to tend to move towards the outer side of the turntable, so that the driven member tends to drive the projection to extend from the turntable.

In one embodiment, the turntable includes a disc-shaped part located below the turntable. The base includes located above the base and is circular, the disc-shaped part being rotatably engaged into the opening; and a blocking part located at an edge of the opening. When the projection is in the locking position, the projection interferes with the blocking part to restrict a rotation range of the turntable with respect to the base.

In one embodiment, the seat is selectively separated from the turntable.

### BRIEF DESCRIPTION OF THE DRAWINGS

FIG. 1 is a side view of a child safety seat in a rearward position;

FIG. 2 is a side view of the child safety seat in a forward position;

FIG. 3 is a front view of a seat in the child safety seat, in which an operating member is in a first position (i.e., a locking position);

FIG. 4 is a front view of the seat in the child safety seat, in which the operating member is in a second position (i.e., an unlocking position);

FIG. 5 is a perspective view of a base and a turntable;

FIG. 6 is a perspective view of the turntable;

FIG. 7 is a perspective view of the base;

FIG. 8 is a side sectional view of the child safety seat taken along a longitudinal axis, in which the anti-misuse mechanism is in an unlocking position;

FIG. 9 is a partially enlarged view of a frame portion of FIG. 8;

FIG. 10 is a side sectional view of the child safety seat taken along the longitudinal axis, in which the anti-misuse mechanism is in a locking position;

FIG. 11 is a partially enlarged view of a frame portion of FIG. 10;

FIG. 12 is a partially exploded perspective view showing the operating member, a linkage, a pushing member and a seat of the anti-misuse mechanism according to the present disclosure;

FIG. 13 is a partially enlarged view of a frame portion of FIG. 12;

FIG. 14 is a bottom perspective view of the operating member of the anti-misuse mechanism according to the present disclosure;

FIG. 15 is a perspective view of a positioning member of the anti-misuse mechanism according to the present disclosure;

FIG. 16 is a side sectional view showing the seat, the turntable, and some parts of the anti-misuse mechanism, in which the anti-misuse mechanism is in the locking position;

FIG. 17 is a partially enlarged view of a frame portion of FIG. 16;

FIG. 18 is a side sectional view showing the seat, the turntable, and some parts of the anti-misuse mechanism, in which the anti-misuse mechanism is in the unlocking position;

FIG. 19 is a partially enlarged view of a frame portion of FIG. 18;

FIG. 20 is a perspective view showing some parts of the turntable and the anti-misuse mechanism;

FIG. 21 is a partially enlarged view of a frame portion of FIG. 20;

FIG. 22 is a perspective view of a driven member of the anti-misuse mechanism according to the present disclosure;

FIG. 23 is a side sectional view showing the turntable and some parts of the anti-misuse mechanism, in which the anti-misuse mechanism is in the unlocking position; and

FIG. 24 is a side sectional view showing the turntable and some parts of the anti-misuse mechanism, in which the anti-misuse mechanism is in the locking position.

### List of Reference Numerals

1 Child Safety Seat
   100 Anti-Misuse Mechanism
   110 Operating Member
      111 Toggling Part
      112 Sliding Part
      113 Positioning Recess
      114 Inclined Surface Part
      115 Ridge
   120 Positioning member
      121 Protrusion
      122 Positioning member Body
      129 Positioning member Spring
   130 Linkage
      131 Handle
      132 Pivot
      133 Fork
   140 Pushing member
   148 Pushing member Pin
   149 Pushing member Spring
   150 Driving member
   158 Driving member Pin
   159 Driving member Spring
   160 Driven member
      161 Side Wall
      162 Sliding Groove
   169 Driven member Spring
   170 Projection
200 Turntable
   210 Disc-Shaped Part
300 Base
   310 Opening
   320 Blocking Part
400 Seat
   410 Crossbar

### DETAILED DESCRIPTION

Although the present disclosure is illustrated and described herein with reference to specific embodiments, the present disclosure should not be limited to the details shown. Rather, various modifications may be made to these details within the scope of equivalents of the claims without departing from the present disclosure.

The descriptions of directions such as “front”, “back”, “upper” and “lower” in this text are only for convenience of understanding, and the present disclosure is not limited to these directions, but can be adjusted according to the actual situations. Although the present disclosure has been described with reference to typical embodiments, the terms used are illustrative and exemplary, but not restrictive.

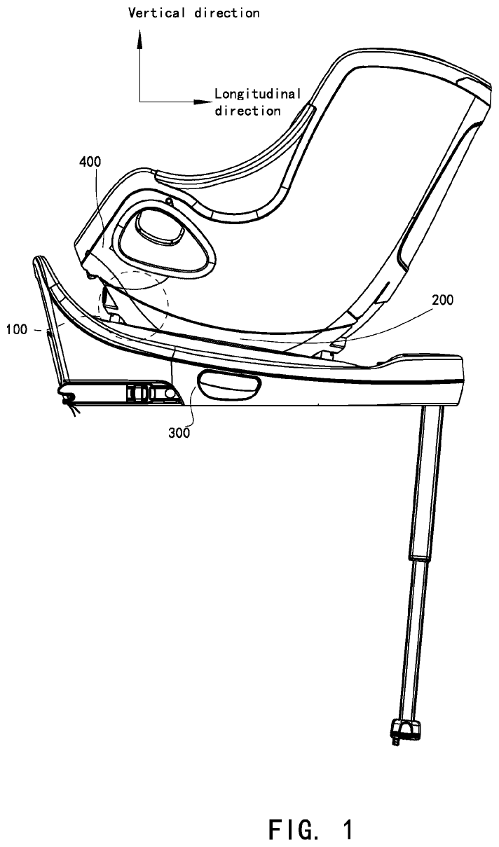

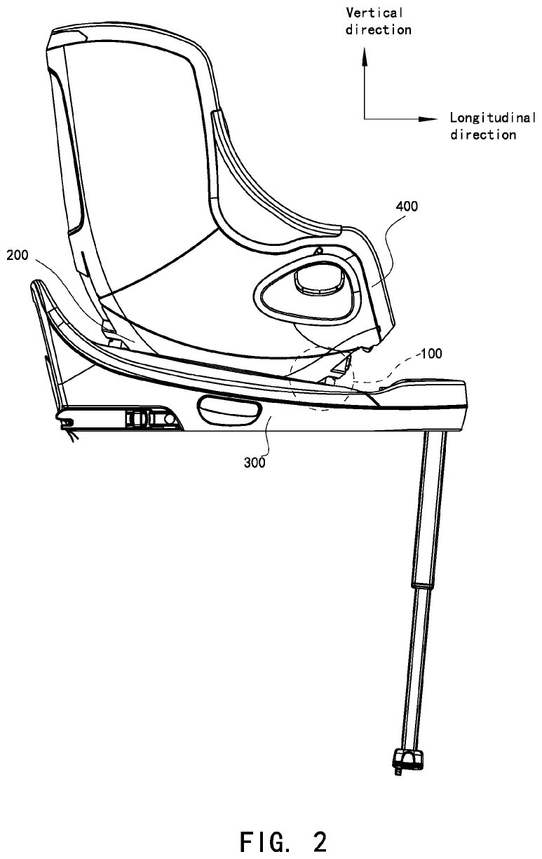

Referring to FIGS. 1 and 2, a child safety seat 1 according to the present disclosure is shown as a whole. The child safety seat 1 includes a base 300, a turntable 200, a seat 400, and an anti-misuse mechanism 100.

The base 300 is located at a lower portion of the child safety seat 1 for securing the child safety seat 1 to a vehicle such as an automobile.

The turntable 200 is located above the base 300 and may rotate between a forward position and a rearward position with respect to the base 300 around a substantial vertical axis.

The seat 400 is located above the turntable 200 and may rotate together with the turntable 200. That is, the turntable 200 may switch the seat 400 between the forward position and the rearward position. Here, the forward position shown in FIG. 2 is a position where the turntable 200 enables the seat 400 to face forward (i.e., a traveling direction of the vehicle), and the rearward position shown in FIG. 1 is a position where the turntable 200 enables the seat 400 to face rearward.

The anti-misuse mechanism 100 is arranged between the base 300, the turntable 200 and the seat 400. The anti-misuse mechanism 100 can prevent or allow the relative rotation between the turntable 200 and the base 300.

In some applications, the seat 400 is configured to be detachably coupled to the turntable 200. The anti-misuse mechanism 100 of the present disclosure is configured to allow separation and engagement between the seat 400 and the turntable 200.

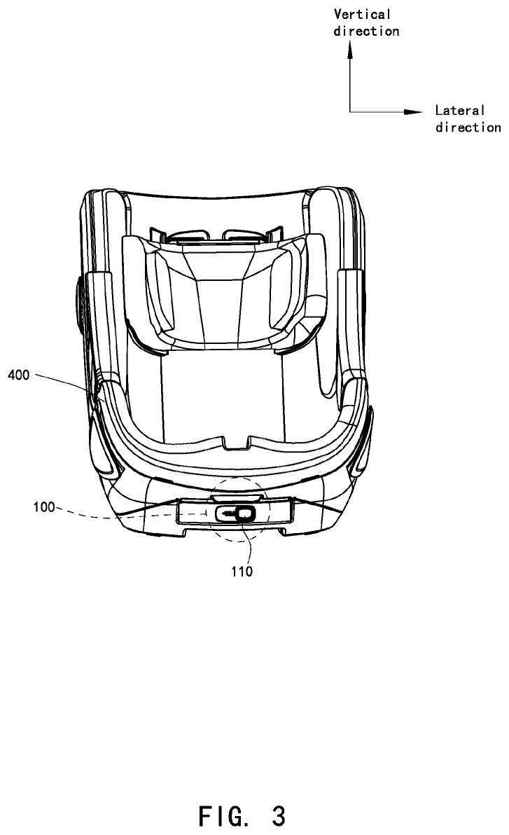

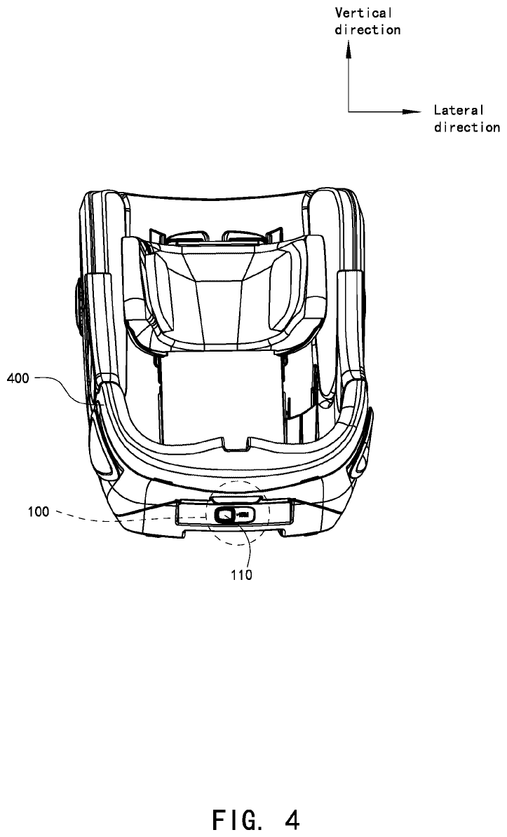

Referring to FIGS. 3 and 4, the seat 400 of the child safety seat 1 is shown.

At least a part of the anti-misuse mechanism 100 is installed in the seat 400, specifically inside a front side of a bottom end of the seat 400. The anti-misuse mechanism 100 includes an operating member 110 for receiving the operation of a user. The operating member 110 is mounted on the seat 400 and may be operated from the outside of the seat 400.

More specifically, the operating member 110 may move with respect to the seat 400 between a first position shown in FIG. 3 and a second position shown in FIG. 4, so as to switch the anti-misuse mechanism 100 between a locking position and an unlocking position.

For example, in the first position shown FIG. 3, the operating member 110 is on the right side in the lateral direction shown in FIG. 3, so that the anti-misuse mechanism 100 is in the locking position. At this time, a rotation range of the turntable 200 (and the seat 400) with respect to the base 300 is restricted, so that the turntable 200 cannot rotate to the forward position. The principle of limiting the rotation range will be described in more detail later. When the operating member 110 is in the first position, a mark of the operating member 110 is exposed outside the seat 400 to remind the user of a current state of the anti-misuse mechanism 100. The mark is “<15M”, for example, indicating that the current state is suitable for children under 15 months.

In the second position shown in FIG. 4, the operating member 110 is on the left side in the lateral direction shown in FIG. 4, so that the anti-misuse mechanism 100 is in the unlocking position. At this time, the rotation range of the turntable 200 (and the seat 400) with respect to the base 300 is not restricted, and the turntable 200 is allowed to rotate to the forward position or to the rearward position. When the operating member 110 is in the second position, another mark of the operating member 110 is exposed outside the seat 400 to remind the user of the current state of the anti-misuse mechanism 100. The mark is “>15M”, for example, indicating that the current state is suitable for children over 15 months.

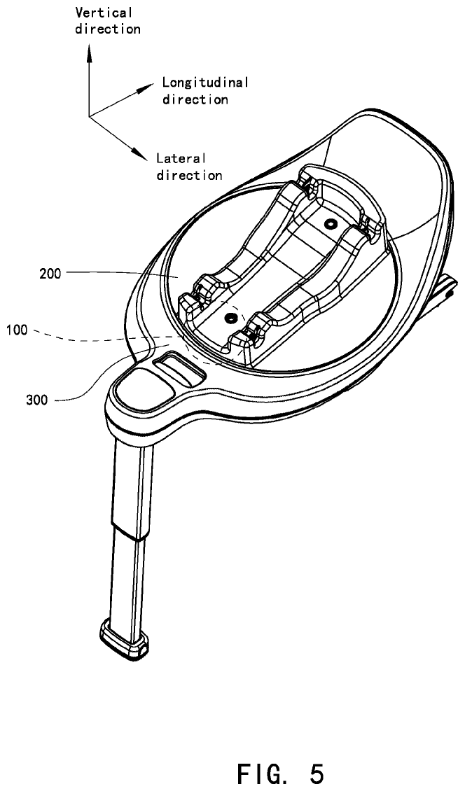

With reference to FIGS. 5 to 7, a principle that the anti-misuse mechanism 100 restricts the rotation range of the turntable 200 with respect to the base 300 will be described.

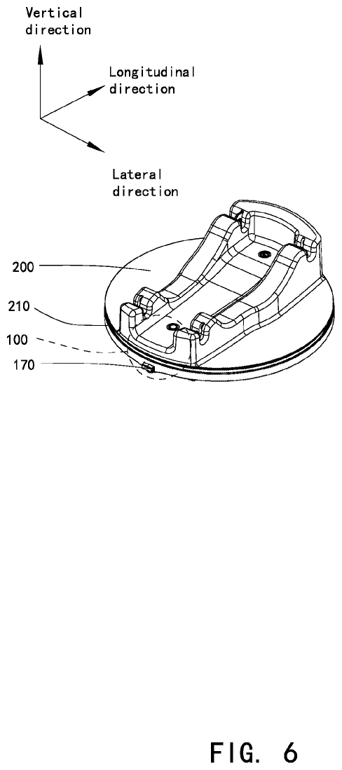

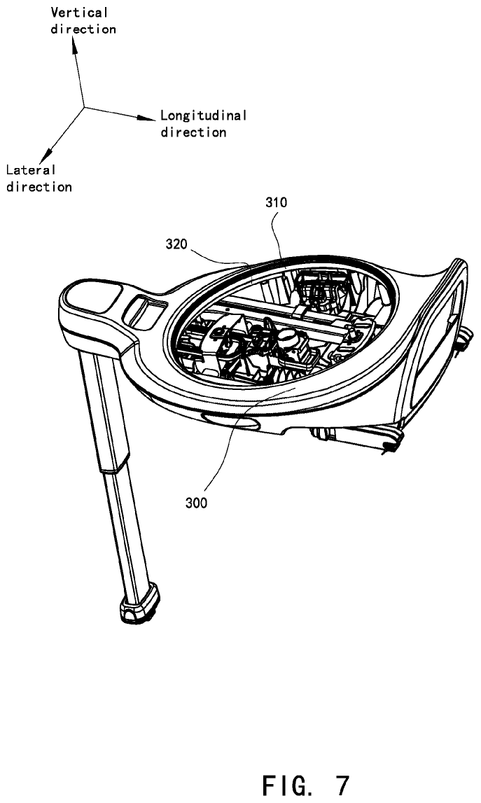

As shown in FIG. 5, the turntable 200 is arranged on the base 300 and may be arranged to rotate about a substantial vertical axis. As shown in FIG. 6, the turntable 200 includes a disk-shaped part 210 located below the turntable 200. At least a part of the anti-misuse mechanism 100 is arranged in the turntable 200, and a projection 170 of the anti-misuse mechanism 100 may extend from an edge of the disc-shaped part 210. As shown in FIG. 7, the base 300 includes an opening 310 and a blocking part 320. The opening 310 is located above the base 300 and has a circular shape. The blocking part 320 is located at an edge of the opening 310. It should understood that the disc-shaped part 210 is rotatably engaged into the opening 310. When the projection 170 is in the locking position, the projection 170 and the blocking part 320 interfere with each other to restrict the rotation range of the turntable 200 with respect to the base 300. For example, the blocking part 320 is arranged along a semicircle of the opening 310. When the projection 170 is in the locking position (i.e., extending from the turntable 200), the projection 170 can only move within a range of a rear semicircle of the opening 310, so the turntable 200 is restricted from rotating to the forward position.

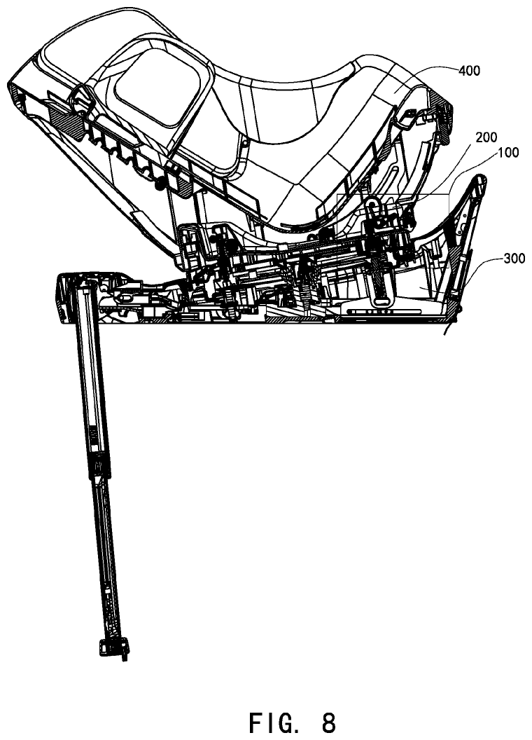

The relationship between the components of the anti-misuse mechanism 100 will be described with reference to FIGS. 8 to 14.

The anti-misuse mechanism 100 includes an operating member 110, a toggling part 111, a sliding part 112, a positioning member 120, a positioning member spring 129, a linkage 130, a pushing member 140, a pushing member pin 148, a pushing member spring 149, a driving member 150, a driving member pin 158, a driving member spring 159, a driven member 160, a driven member spring 169, and a projection 170.

The operating member 110 is arranged in the seat 400 and transversely moves with respect to the seat 400 between the first position and the second position (perpendicular to the paper showing FIGS. 8 to 11) according to the operation of the user. According to the design of the present disclosure, when the operating member 110 approaches the first position across an intermediate position between the first position and the second position, the operating member 110 automatically moves to the first position; and when the operating member 110 approaches the second position across the intermediate position, the operating member 110 automatically moves to the second position, which will be explained in detail later.

The positioning member 120 is arranged on the seat 400 and abuts against the operating member 110, so as to automatically move the operating member 110 to the first position or the second position when the operating member 110 approaches the first position or the second position, which will be described in detail later.

The positioning member spring 129 is arranged between the positioning member 120 and the seat 400, and biases the protrusion 121 of the positioning member 120 upward.

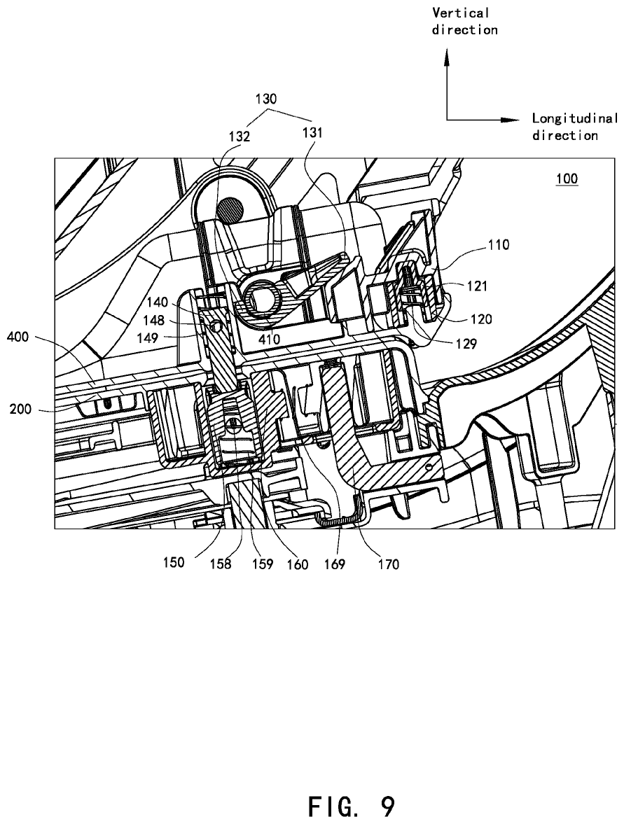

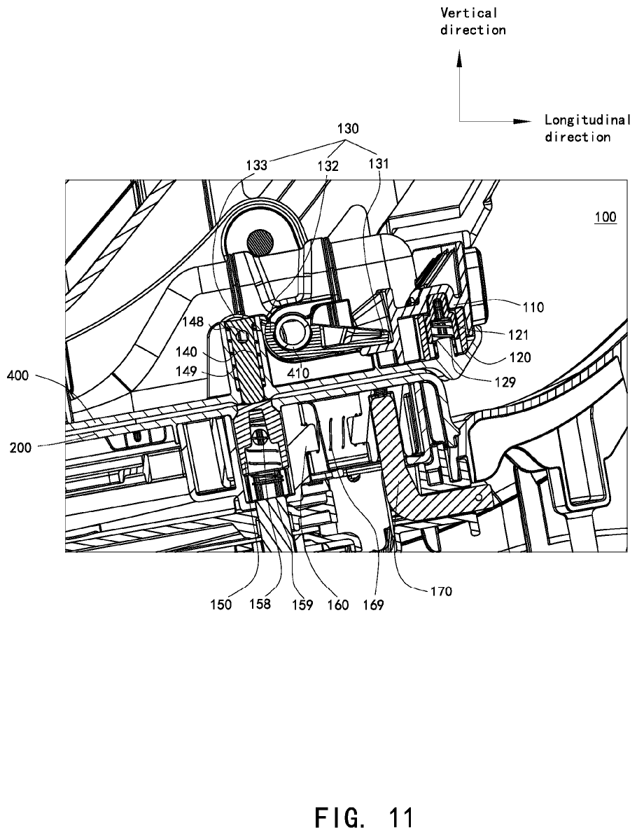

The linkage 130 extends longitudinally towards the inside of the seat 400 and swings about a transverse axis (i.e., around the crossbar 410). The operating member 110 abuts against one end of the linkage 130 (i.e., an end where the handle 131 is located, see FIGS. 9 and 11), and the transverse movement of the operating member 110 will drive the linkage 130 to swing. It should be understood that the linkage 130 may extend in different directions, for example, in an inclined direction.

The pushing member 140 is vertically arranged in the seat 400, and is restricted to be vertically movable. The other end of the linkage 130 with respect to the handle 131 is engaged to an upper end of the pushing member 140, and the swinging of the linkage 130 drives the pushing member 140 to move vertically. It should be understood that the pushing member 140 may be arranged in other directions and/or moved in other directions, for example, arranged obliquely and/or moved obliquely.

The pushing member pin 148 is inserted between the pushing member 140 and the linkage 130 to allow interaction between the pushing member 140 and the linkage 130, which will be described in detail later.

The pushing member spring 149 is arranged between the pushing member 140 and the seat 400, and biases the pushing member 140 upward.

The driving member 150 is arranged in the turntable 200, vertically below the pushing member 140, and is arranged to movable vertically. A lower end of the pushing member 140 abuts against an upper end of the driving member 150, and the vertical movement of the pushing member 140 causes the driving member 150 to move vertically.

The driving member spring 159 is arranged between the driving member 150 and the turntable 200 to bias the driving member 150 upward.

It can be understood that the driving member 150 and the pushing member 140 are located in the turntable 200 and the seat 400, respectively. When the turntable 200 and the seat 400 separated from each other, the driving member 150 and the pushing member 140 are also separated from each other accordingly. When the seat 400 is engaged to the turntable 200, the pushing member 140 extends from the bottom of the seat 400 and enters the turntable 200 from the top of the turntable 200, so as to push the driving member 150 downward.

The driven member 160 is arranged in the turntable 200 in the longitudinal direction and is restricted to be longitudinally movable. The driven member 160 is coupled with the driving member 150, so that the vertical movement of the driving member 150 can drive the driven member 160 to move longitudinally.

The driven member spring 169 is arranged between the driven member 160 and the turntable 200, and biases the driven member 160 so that the driven member 160 tends to approach the outside of the turntable 200, that is, the driven member 160 tends to drive the projection 170 to protrude from the seat 400.

The projection 170 is at least partially arranged in the turntable 200 and may move between a locking position in which the projection extends from the turntable 200 and an unlocking position in which the projection is retracted into the turntable 200. The projection 170 is arranged at a position of the driven member 160 near the outside of the turntable 200, and the longitudinal movement of the driven member 160 drives the projection 170 to move between the locking position and the unlocking position.

As shown in FIGS. 8 and 9, the anti-misuse mechanism 100 is in the unlocking position. At this time, the operating member 110 is in the first position, and an end of the linkage 130 abutting against the operating member 110 is lifted upward. An end of the linkage 130 opposite to the operating member 110 is pressed downward, driving the pushing member 140 to move downward. The pushing member 140 presses the driving member 150, and the driving member 150 drives the driven member 160 to move toward the inside of the turntable 200. Therefore, the projection 170 provided to the driving member 150 is retracted into the turntable 200.

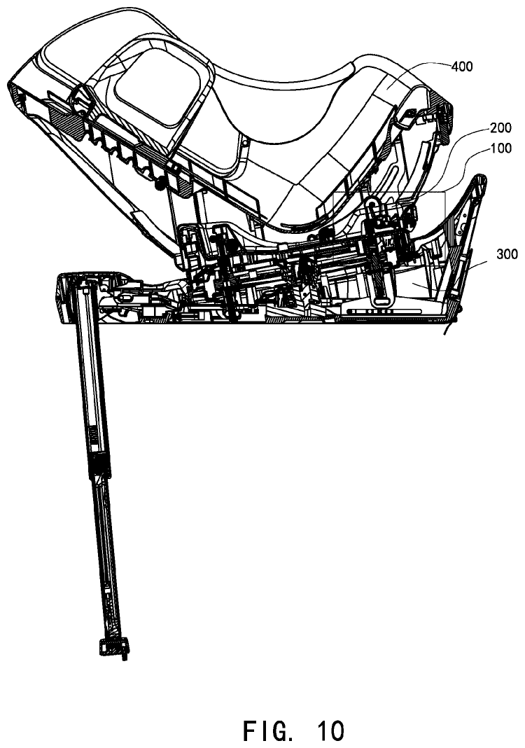

As shown in FIGS. 10 and 11, when the user moves the operating member 110 to the second position, the operating member 110 no longer pushes the end of the linkage 130 abutting against the operating member 110 upward, and the end of the linkage 130 opposite to the operating member 110 no longer pushes the pushing member 140 downward. Therefore, the pushing member 140 is reset upward under the action of the pushing member spring 149, and drives the linkage 130 to rotate clockwise to reset. Since the pushing member 140 no longer pushes the driving member 150 downward, the driving member 150 is reset upward under the action of the driving member spring 159, and the driven member 160 is no longer driven to move into the turntable 200. The driven member 160 is reset towards the outside of the turntable 200 under the action of the driven member spring 169, driving the projection 170 to extend from the turntable 200, so that the anti-misuse mechanism 100 is in the locking position.

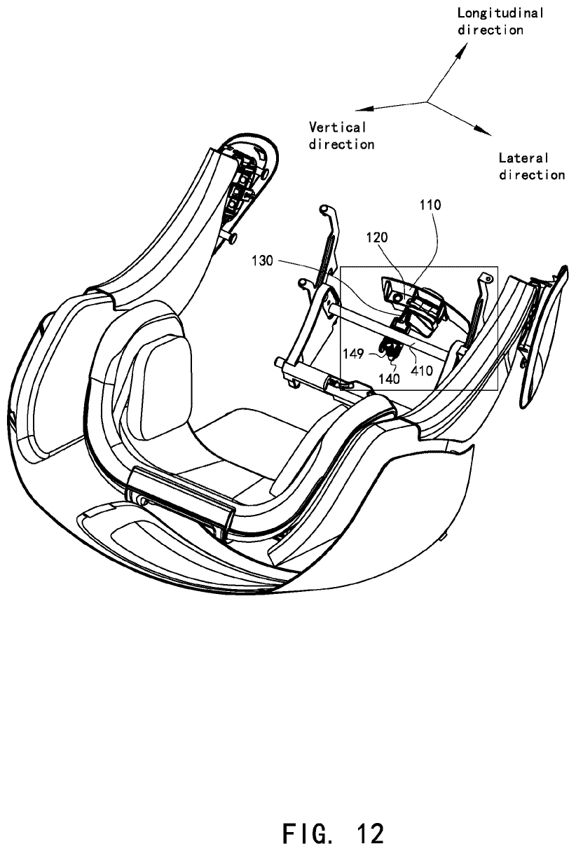

The structures of the operating member 110, the positioning member 120 and the pushing member 140 are described with reference to FIGS. 12 to 15.

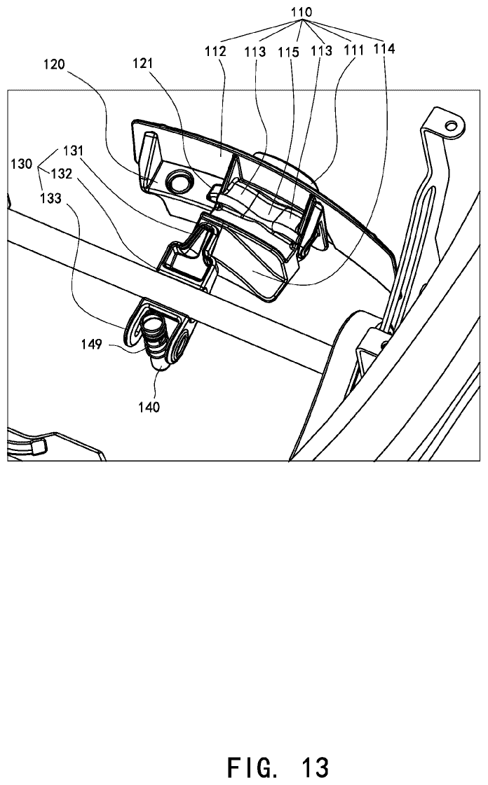

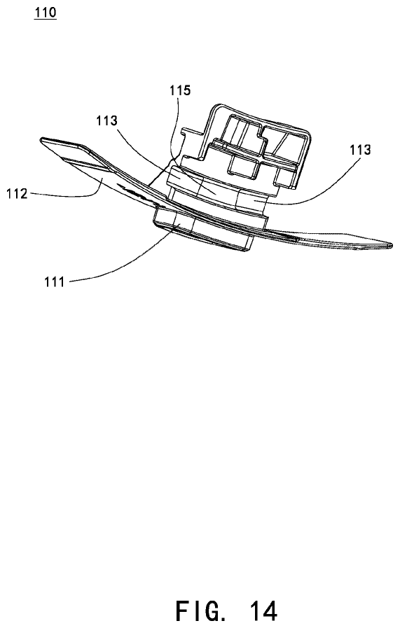

As shown in FIGS. 13 to 14, the operating member 110 includes a sliding part 112, a toggling part 111, two positioning recesses 113, an inclined surface part 114 and a ridge 115.

The sliding part 112 extends in the lateral direction and may slide against an outer surface of the seat 400 (that is, against the child safety seat 1). The toggling part 111 is connected to an outer side of the sliding part 112, exposed to the outside of the seat 400, and may drive the sliding part 112 to move transversely with respect to the seat 400. The outer side of the sliding part 112 may have marks, and the marks may be located on both sides of the toggling part 111 (referring to FIGS. 3 and 4) respectively, so that the user can easily understand a state of the anti-misuse mechanism 100. It should be understood that the sliding part 112 may also be arranged to extend in other directions, such as vertically, obliquely, or curvedly. The sliding part 112 may be attached to the outer surface of the seat 400, embedded in the seat 400 or suspended outside the seat 400. The toggling part 111 may be exposed to the outside of the seat 400 or may be hidden in the seat 400.

The two positioning recesses 113 are located inside the sliding part 112, located in the transverse middle of the sliding part 112, and are symmetrical with respect to the vertical center of the sliding part 112. It should be understood that the two positioning recesses 113 may also be asymmetrically arranged at one side of the sliding part 112 or at both sides of the sliding part 112 in the lateral direction. Each of the positioning recesses 113 extends in an cambered shape with respect to the sliding part 112 from a middle position in the lateral direction. A ridge 115 is formed between the two positioning recesses 113, and the ridge 115 protrudes downward with respect to the positioning recesses 113. That is, a bottom surface of the operating member 110 forms a shape, having two side portions thereof higher than a middle portion, at the positioning recess 113 and the ridge 115 in the lateral direction. The ridge 115 protrudes towards the positioning member 120 and abuts against the protrusion 121 of the positioning member 120, so that the operating member 110 automatically moves to the first position or the second position. The ridge 115 is cambered at a position facing towards the protrusion 121 to prevent the ridge 115 from being stuck with the protrusion 121.

The inclined surface part 114 is formed inside the positioning recess 113 in the longitudinal direction, and an upper surface of the inclined surface part 114 extends obliquely in a manner that one end thereof is higher than the other end in the lateral direction. It should be understood that the inclined surface part 114 may also be formed at different positions, for example, vertically above, vertically below, or at one transverse side of the positioning recess 113, or between the positioning recess 113 and the sliding part 112, as long as it may abut against the handle 131 of the linkage 130.

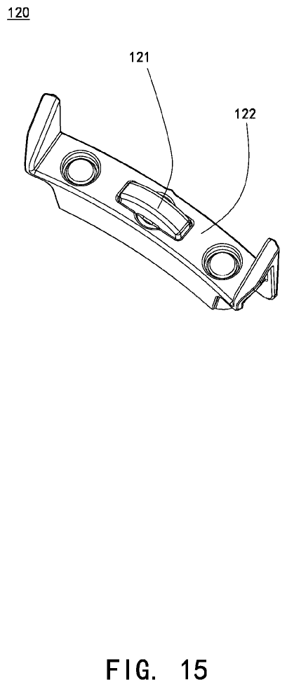

As shown in FIG. 15, the positioning member 120 is located vertically below the operating member 110. In other embodiments, the positioning member 120 may also be located in other directions of the operating member 110, as long as the positioning recess 113 and the ridge 115 may abut against the protrusion 121. The positioning member 120 includes a positioning member body 122 and a protrusion 121. The positioning member body 122 is generally rectangular and arranged in the seat 400. The protrusion 121 is longitudinally movable in the positioning part body 122, and has an arc-shaped protrusion 121 adapted to the positioning recess 113. The positioning member spring 129 biases the protrusion 121 upward. When the operating member 110 approaches the intermediate position, the protrusion 121 abuts against the ridge 115, so that the operating member 110 automatically moves to the first position or the second position. When the operating member 110 approaches the first position or the second position across the intermediate position, the protrusion 121 abuts against the corresponding positioning recess 113 and pushes the operating member 110 to the first position or the second position.

More specifically, the above-mentioned intermediate position refers to a position where the ridge 115 of the operating member 110 just corresponds to a top end of the arc-shaped protrusion 121.

As shown in FIG. 13, the linkage 130 includes a handle 131, a pivot 132 and a fork 133.

The handle 131 is located at one longitudinal end of the linkage 130, and is kept against the upper surface of the inclined surface part 114. It should be understood that the handle 131 may also be formed at other positions of the linkage 130, such as at a vertical upper end, vertical lower end or at one transverse side of the linkage 130, as long as it abuts against the sliding part 112.

The pivot 132 is spaced apart from the handle 131, and the linkage 130 may swing about the pivot 132. More specifically, the pivot 132 is arc-shaped groove opened upward and extending transversely, and is engaged under a crossbar 410 installed on the seat 400, so that the linkage 130 may swing about the crossbar 410. It should be understood that the pivot 131 may be located at the longitudinal middle of the linkage 130 or near any end of the linkage 130, and the pivot 132 may also be in other shapes as long as it can be pivotally engaged to the crossbar 410.

The fork 133 is located at the other end of the linkage 130 in the longitudinal direction, and has two arms extending in the longitudinal direction and symmetrically arranged on both sides with respect to the longitudinal center of the pushing member 140 in the lateral direction, and the pushing member 140 is pivotally connected between the two arms through a pushing member pin 148 (see FIGS. 9 and 11). It should be understood that the arms may also extend in other directions, such as obliquely, and the two arms may be arranged asymmetrically.

When the operating member 110 moves from the first position to the second position or from the second position to the first position, the handle 131 abuts against and slides on the upper surface of the inclined surface part 114 and moves in the vertical direction, thereby driving the linkage 130 to swing.

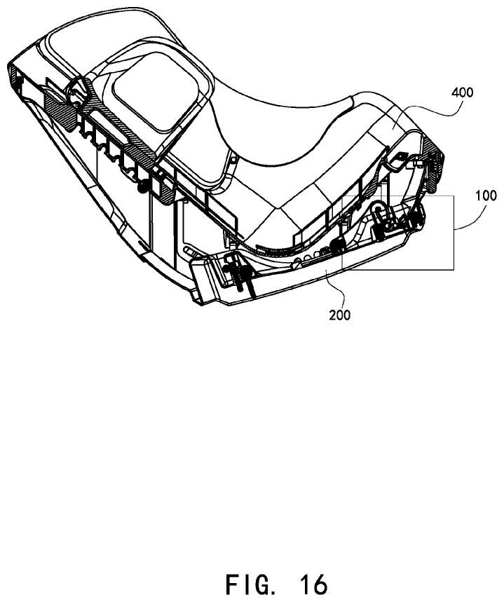

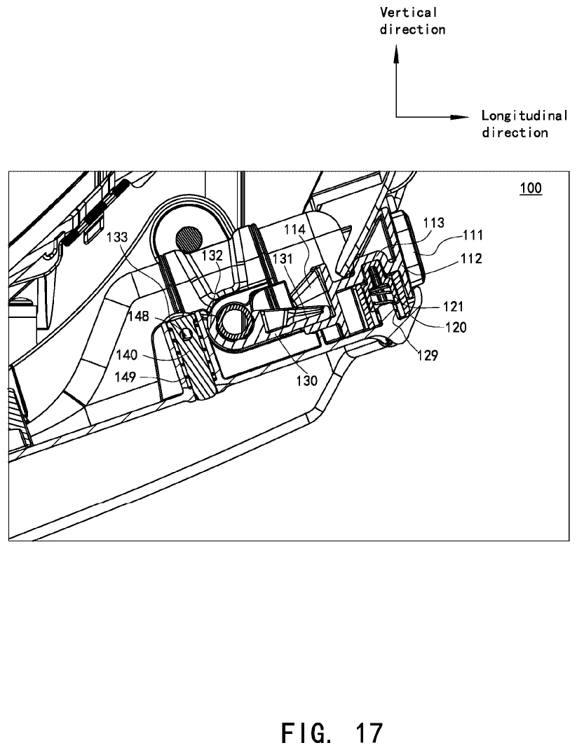

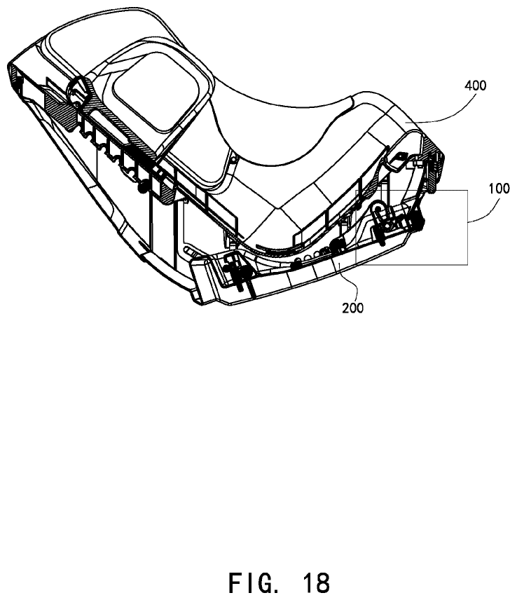

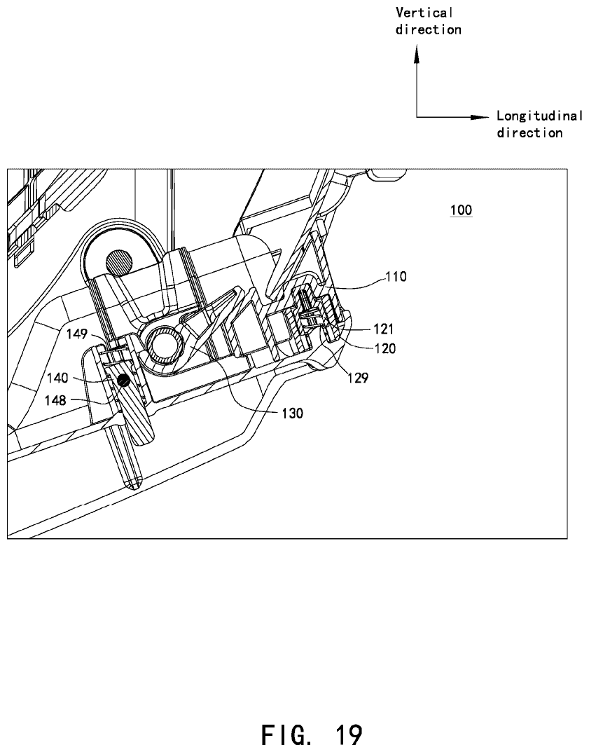

FIGS. 16 to 19 show interactions between the operating member 110, the positioning member 120, the linkage 130 and the pushing member 140 more clearly.

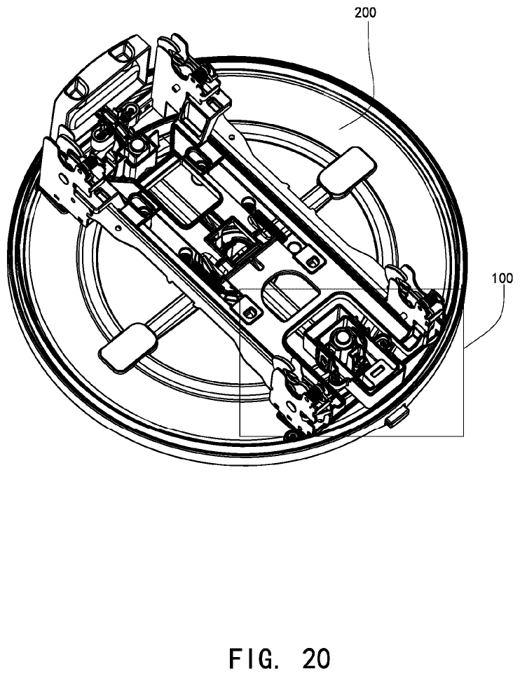

The specific structure of the driven member 160 will be described with reference to FIGS. 20 to 24.

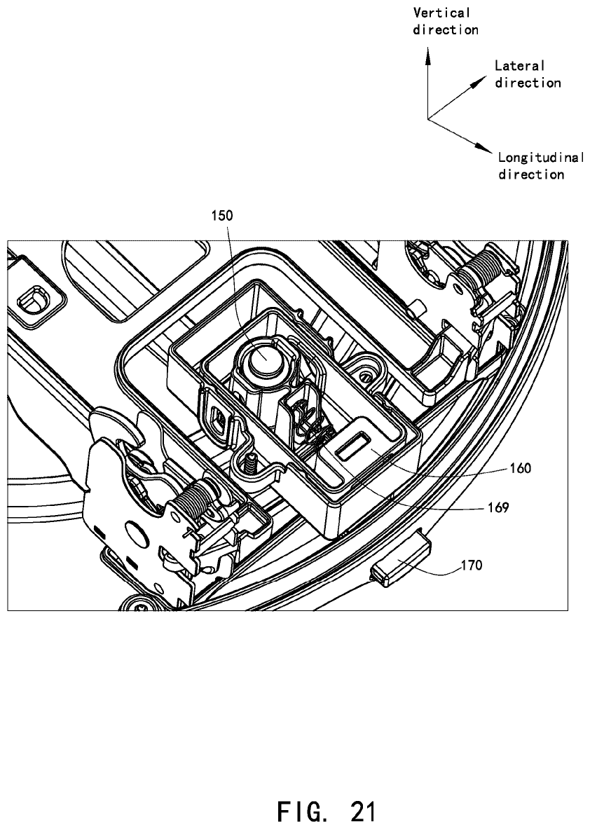

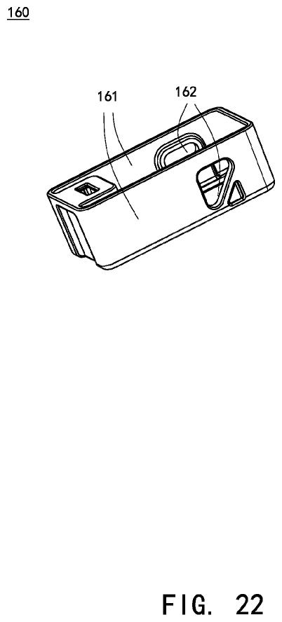

As shown in FIGS. 21 and 22, the driven member 160 is substantially box-shaped, and has two side walls 161 each extending in the longitudinal direction and an opened top portion, and each of the side walls 161 is longitudinally symmetrically provided with a sliding groove 162 with an inclined edge. More specifically, each of the sliding groove 162 is a groove with an approximate right triangle, and a hypotenuse of the right triangle is located on the longitudinal side of the sliding groove 162 and serves as the inclined edge. It should be understood that the driven member 160 may also be in other shapes, as long as the sliding groove 162 can be formed therewith and the projection 170 can be connected thereto.

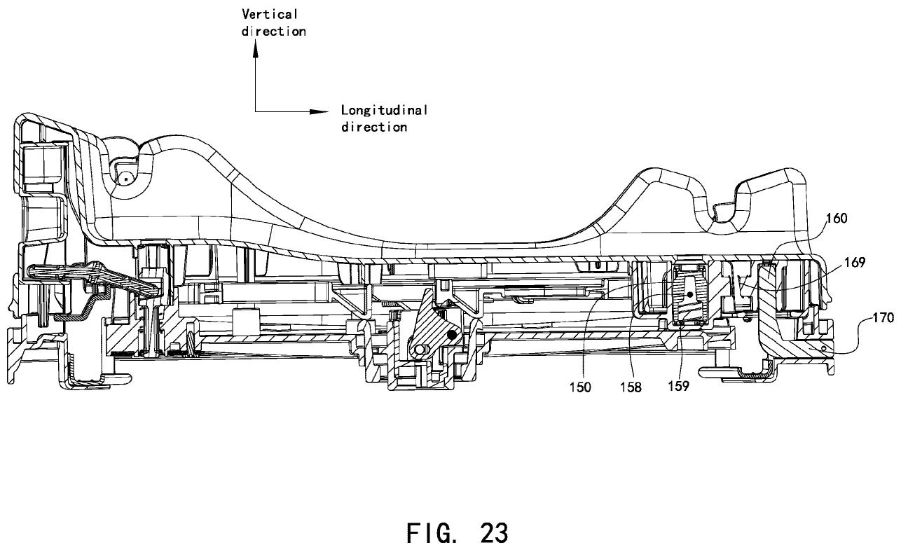

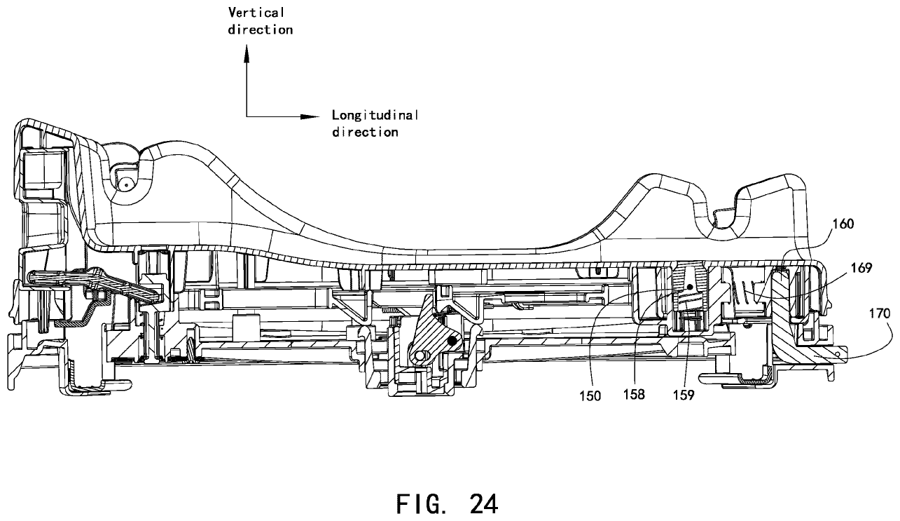

As shown in FIGS. 23 and 24, the driving member 150 is hollow and generally cylindrical. The driving member 150 is provided with driving member pins 158 that extend transversely outward from opposite sides of the driving member 150. Each of the driving member pin 158 is inserted into the corresponding sliding groove 162, and kept against the corresponding inclined edge.

With reference to FIGS. 23 and 24, the interactions between the driving member 150, the driven member 160 and the projection 170 may be more clearly understood.

As the present disclosure can be embodied in various forms without departing from the spirit and essence of the present disclosure, it should be understood that the above-mentioned embodiments are not limited to any of the foregoing details, but should be interpreted as broadly as possible within the scope defined by the claims, and therefore all changes that fall within the scope of the claims or their equivalents should be covered by the claims of the present disclosure.

1. A child safety seat, wherein the child safety seat comprises:
a base;
a turntable located above the base and rotatable between a forward position and a rearward position with respect to the base about a substantially vertical axis;
a seat located above the turntable and rotatable together with the turntable, wherein the forward position is a position where the turntable enables the seat to face forward, and the rearward position is a position where the turntable enables the seat to face rearward; and
an anti-misuse mechanism arranged between the base, the turntable and the seat, and comprising an operating member, wherein the operating member is mounted on the child safety seat and is movable between a first position and a second position with respect to the seat, so that the anti-misuse mechanism prevents or allows a relative rotation between the turntable and the base;
wherein, when the operating member passes over an intermediate position between the first position and the second position and approaches the first position, the operating member automatically moves to the first position; and when the operating member passes over an intermediate position and approaches the second position, the operating member automatically moves to the second position.

2. The child safety seat according to claim 1, wherein the anti-misuse mechanism further comprises:
a positioning member disposed on the child safety seat and abuts against the operating member for automatically moving the operating member to the first position or the second position when the operating member approaches the first position or the second position.

3. The child safety seat according to claim 2, wherein:
the operating member comprises a ridge, and the ridge protrudes towards the positioning member and abuts against the positioning member, so that the operating member automatically moves to the first position or the second position.

4. The child safety seat according to claim 3, wherein:
the operating member comprises:
a sliding part slidable with respect to the child safety seat; and
two positioning recesses disposed on the sliding part;
the positioning member comprises a protrusion;
when the operating member is positioned near to the intermediate position, the protrusion abuts against the ridge, so that the operating member automatically moves to the first position or the second position; and after the operating member passes over the intermediate position and approaches the first position or the second position, the protrusion abuts against a corresponding positioning recess and pushes the operating member to the first position or the second position.

5. The child safety seat according to claim 4, wherein the operating member further comprises:
a toggling part connected to the sliding part and configured to drive the sliding part to slide with respect to the child safety seat.

6. The child safety seat according to claim 4, wherein:
each of the positioning recesses extends with respect to the sliding part in a cambered shape, and the protrusion has an arc profile adapted to the positioning recess.

7. The child safety seat according to claim 4, wherein:
the positioning member comprises a positioning member body, and the protrusion is movable with respect to the positioning member body.

8. The child safety seat according to claim 4, wherein:
the ridge is formed between the two positioning recesses, and the ridge is cambered at a position facing towards the protrusion.

9. The child safety seat according to claim 4, wherein:
the anti-misuse mechanism further comprises a linkage swinging about a transverse axis, and the operating member abuts against one end of the linkage, and a transverse movement of the operating member drives the linkage to swing.

10. The child safety seat according to claim 9, wherein:
the operating member comprises an inclined surface part, and an upper surface of the inclined surface part extends obliquely in a manner that one end thereof is higher than the other end in a lateral direction;
the linkage comprises a handle kept against the upper surface of the inclined surface part; and a pivot spaces apart from the handle, the linkage is configured to swing about the pivot;
when the operating member moves from the first position to the second position or from the second position to the first position, the handle abuts against and slides on the upper surface of the inclined surface and moves in a vertical direction to drive the linkage to swing.

11. The child safety seat according to claim 10, wherein:
the pivot is engaged under a crossbar installed on the seat, so that the linkage is capable of swinging about the crossbar.

12. The child safety seat according to claim 11, wherein, the anti-misuse mechanism further comprises:
a pushing member arranged in the seat and restricted to move vertically;
the other end of the linkage with respect to the handle is coupled to an upper end of the pushing member, and the linkage is swung to drive the pushing member to move vertically.

13. The child safety seat according to claim 12, wherein:
the linkage further comprises a fork located at the other end of the linkage with respect to the handle, and having two arms arranged on both sides in the lateral direction with respect to a longitudinal center of the pushing member, and the pushing member is pivotally connected between the two arms through a pushing member pin.

14. The child safety seat according to claim 13, wherein, the anti-misuse mechanism further comprises:
a driving part arranged in the turntable, vertically below the pushing part, and restricted to be movable vertically;
a lower end of the pushing member abuts against the upper end of the driving member, and a vertical movement of the pushing member enables the driving member to move vertically.

15. The child safety seat according to claim 14, wherein, the anti-misuse mechanism further comprises:
a driven member arranged in the turntable and restricted to move in a longitudinal direction;
wherein the driven member is coupled with the driving part, so that a vertical movement of the driving part drives the driven member to move longitudinally.

16. The child safety seat according to claim 15, wherein:
the driven member is provided with two side walls extending longitudinally and an opened top part, and each of the side walls is symmetrically provided with a sliding groove with an inclined edge with respect to the longitudinal direction;
the driving member is provided with a driving member pin extending transversely outward from each of opposite sides of the driving member, and the driving member pin is inserted into the corresponding sliding groove and kept against the corresponding inclined edge.

17. The child safety seat according to claim 16, wherein, the child safety seat further comprises:
a projection at least partially arranged in the turntable and being movable between a locking position in which the projection extends from the turntable and an unlocking position in which the projection is retracted into the turntable;
wherein the projection is arranged a position where the driven member is near an outer side of the turntable, and a longitudinal movement of the driven member drives the projection to move between the locking position and the unlocking position.

18. The child safety seat according to claim 17, wherein, the anti-misuse mechanism further comprises:
a positioning member spring arranged between the positioning member and the seat, and biasing the positioning member upwards;
a pushing member spring arranged between the pushing member and the seat, and biasing the pushing member upwards; and
a driving member spring arranged between the driving member and the turntable, and biasing the driving member upwards.

19. The child safety seat according to claim 18, wherein,
the sliding groove is a groove having a shape of an approximately right triangle, and a hypotenuse of the right triangle is located at a side of the sliding groove in the longitudinal direction and acts as the inclined edge;
the anti-misuse mechanism further comprises a driven member spring, the driven member spring is arranged between the driven member and the turntable, and biases the driven member to tend to move towards the outer side of the turntable, so that the driven member tends to drive the projection to extend from the turntable.

20. The child safety seat according to claim 17, wherein:
the turntable comprises:
a disc-shaped part located below the turntable;
the base comprises:
an opening located above the base and is circular, the disc-shaped part being rotatably engaged into the opening; and
a blocking part located at an edge of the opening;
when the projection is in the locking position, the projection interferes with the blocking part to restrict a rotation range of the turntable with respect to the base.

21. (canceled)
